(19) United States
(12) Patent Application Publication
(10) Pub. No.: US 2011/0307672 A1
(43) Pub. Date: Dec. 15, 2011

(54) MEMORY INTERFACE WITH INTERLEAVED CONTROL INFORMATION

(75) Inventor: Frederick A. Ware, Los Altos Hills, CA (US)

(73) Assignee: RAMBUS INC., Los Altos, CA (US)

(21) Appl. No.: 13/139,698

(22) PCT Filed: Feb. 25, 2010
(86) PCT No.: PCT/US10/25316

§ 371 Date: Jun. 14, 2011

Related U.S. Application Data
(60) Provisional application No. 61/158,225, filed on Mar. 6, 2009.

(51) Int. Cl. G06F 12/00

(52) U.S. Cl. 711/157; 711/E12.001

(57) ABSTRACT

A memory system communicates at least partially temporally overlapping write-data sequences associated with independent column write accesses on data links from a memory controller to a memory device via bidirectional links. Each of these write-data sequences may be associated with a different bank set in the memory IC. These bank sets may be micro-threaded so that each bank set is independently addressable and can concurrently perform operations associated with independent commands, including simultaneous column read/write. Furthermore, temporally interleaved data-mask information for the write-data sequences may be communicated from the memory controller to the memory IC via a data-mask link, so that alternate bits in the interleaved data-mask information may correspond to different write sequences.

### TECHNICAL FIELD

The present embodiments relate to techniques for communicating information between integrated circuits. More specifically, the present embodiments relate to circuits and methods for communicating interleaved data-mask information between a memory controller and a memory integrated circuit.

### BACKGROUND

Memory controllers operate by communicating data, addresses or commands to one or more memory integrated circuits (ICs) through signal lines (which are also referred to as ‘links’). In many memory systems, one or more links constitute a shared resource. For example, a data-mask (DM) link can be used to communicate data-mask information for write data communicated on different data (DQ) links. The data-mask information may be used to control the masking of write-data bits in the data streams that are communicated on the different data DQ links, where block(s) of data-mask bits may correspond to an entire write-data-sequence.

Because of different data rates on the DM link and the DQ links, the data-mask information may need to be temporarily stored in the memory IC. The size of the memory used to temporarily store the data-mask information may increase with the ever-increasing complexity of memory integrated circuits, resulting in increased cost and power consumption of the memory IC.

### BRIEF DESCRIPTION OF THE FIGURES

FIG. 1 depicts a memory system with interleaved data-mask information during communication between a memory controller and a memory IC in accordance with an embodiment.

FIG. 2 depicts a method for communicating interleaved data-mask information between the memory controller and the memory IC in the memory system of FIG. 1 in accordance with an embodiment.

FIG. 3A depicts a timing diagram for communication between the memory controller and the memory IC in the memory system of FIG. 1 in accordance with an embodiment.

FIG. 3B depicts a timing diagram for communication between the memory controller and the memory IC in the memory system of FIG. 1 in accordance with an embodiment.

FIG. 4 depicts a memory system with interleaved data-mask information during communication between a memory controller and memory ICs in accordance with an embodiment.

FIG. 5A depicts a timing diagram for communication between the memory controller and the memory IC in the memory system of FIG. 4 in accordance with an embodiment.

FIG. 5B depicts a timing diagram for communication between the memory controller and the memory IC in the memory system of FIG. 4 in accordance with an embodiment.

### DETAILED DESCRIPTION

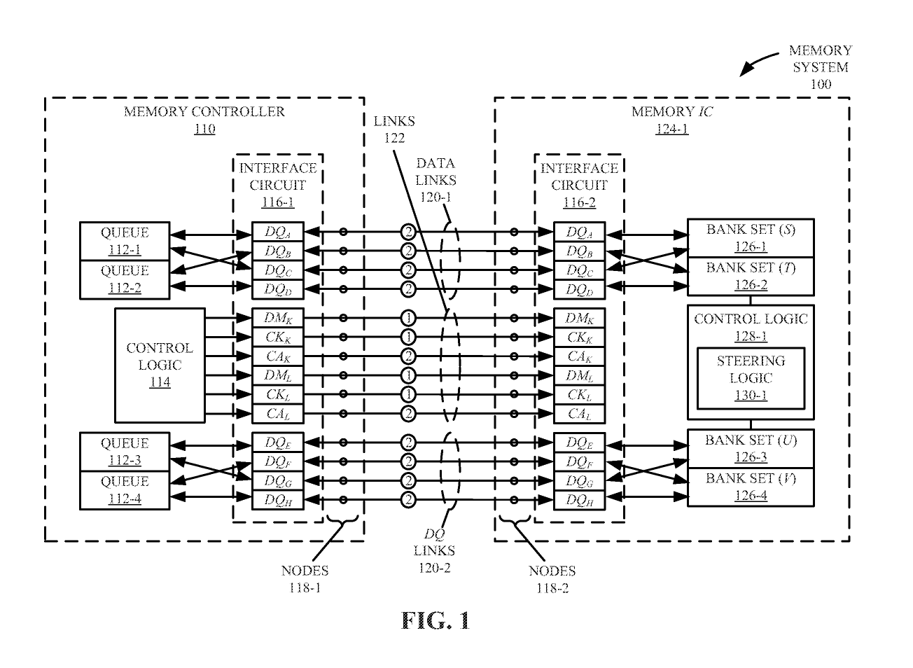

FIG. 1 presents a memory system 100 with a memory controller 110 coupled to a memory device 124-1, which can be a memory IC, via bidirectional data (DQ) links 120 and links 122. Data links 120 include data links 120-1 and data links 120-2. Data links 120-1 are connected between respective ones of data interface circuits (e.g., DQ_{A}, DQ_{B}, DQ_{C} and DQ_{D}) in memory controller 110 and respective ones of interface circuits (e.g., DQ_{A}, DQ_{B}, DQ_{C} and DQ_{D}) in memory IC 124-1 through their respective external nodes 118. Likewise, data links 120-2 are connected between respective ones of data interface circuits (e.g., DQ_{E}, DQ_{F}, DQ_{G} and DQ_{H}) in memory controller 110 and respective ones of data interface circuits (DQ_{E}, DQ_{F}, DQ_{G} and DQ_{H}) in memory IC 124-1 through their respective external nodes 118. Links 122 includes data mask links coupled between respective data-mask (DM) interfaces (e.g., DM_{K} and DM_{L}) in memory controller 110 and respective data-mask interfaces (e.g., DM_{K} and DM_{L}) in memory IC 124-1 through their respective external nodes 118. Links 122 also includes command (CA) links coupled between respective command interfaces (e.g., CA_{K} and CA_{L}) in memory controller 110 and respective command interfaces (e.g., CA_{K} and CA_{L}) in memory IC 124-1 through their respective external nodes 118. Links 122 further include clock (CK) links coupled between respective clock interfaces (e.g., CL_{K} and CL_{L}) in memory controller 110 and respective clock interfaces (e.g., CL_{K} and CL_{L}) in memory IC 124-1 through their respective external nodes 118. Links 122 and data links 120 may each include one or more signal lines (as indicated by the illustrative numerical values in the circles). For example, the data link coupled between interface circuits DQ_{A} may include two signal lines, so that two bits of data DQ_{A}[1:0] may be conveyed by the data link in parallel.

For ease of discussion, the aforementioned interface circuits in memory controller 110 may individually or collectively be referred to as interface circuit 116-1, and the aforementioned interface circuits in memory IC 124-1 may individually or collectively be referred to as interface circuit 116-2. In one embodiment, interface circuit 116-1 or 116-2 may include a driver (not shown) and a receiver (not shown) corresponding to each bidirectional signal line in data links 120. Interface 116-1 may include a driver (not shown) corresponding to each signal line in links 122, and interface 116-2 may include a receiver (not shown) corresponding to each signal line in links 122. The drivers and receivers in interface circuits 116-1 and 116-2 may be implemented using conventional signal driver and receiver circuits.

During communication of write data from memory controller 110 to memory IC 124-1, DM links in links 122 convey interleaved data-mask information. In particular, when system 100 performs two or more independent column write accesses (at addresses in two or more corresponding bank sets 126), in accordance with signals from control logic 114, at a respective time, interface circuit 116-1 transmit at least partially temporally overlapping write-data sequences from two or more queues 112 corresponding to the two or more independent column write accesses as amplitude-modulated electrical signals on at least two of data links 120. For example, a first write-data sequence from queue 112-1 for bank set (S) 126-1 may be conveyed on data links associated with interface circuits DQ_{A} and DQ_{C}, and a second write-data sequence from queue 112-3 for bank set (U) 126-3 may be conveyed on data links associated with interface circuits DQ_{E} and DQ_{G}. (Similarly, data may be conveyed between queue 112-2 and bank set (T) 126-2 via data links associated with interface circuits DQ_{B} and DQ_{D}, and data may be conveyed between queue 112-4 and bank set (V) 126-4 via data links associated with interface circuits DQ_{F} and DQ_{H}.). In addition, in accordance with signals from control logic 114, interleaved data-mask information for these two write-data sequences may be transmitted from memory controller 110 as amplitude-modulated electrical signals on at least one corresponding data-mask link associated with one of the DM interface circuits, such as the data-mask link associated with interface circuit DM_{K}. This interleaved data-mask information includes data-mask bits corresponding to the first write-data sequence and data-mask bits corresponding to the second write-data sequence on data links, which identify the unmasked portions of the first write-data sequence and the second write-data sequence, respectively. For ease of discussion, the data-mask bits corresponding to all or any portion (or group) of the data bits in the first data sequence may be referred to below as first data-mask information, and the data-mask bits corresponding to all or any portion (or group) of the data bits in the second data sequence may be referred to below as second data-mask information.

Interface circuits in interface circuit 116-2 sample and quantize these electrical signals to recover the digital write-data sequences and the digital data-mask information. In accordance with signals from control logic 128-1, the first write-data sequence is routed to bank set (S) 126-1, and the second write-data sequence is routed to bank set (U) 126-3. In addition, steering logic 130-1 in control logic 128-1 selectively routes or steers the interleaved first data-mask information and second data-mask information to bank sets (S) 126-1 and (U) 126-3, respectively. In accordance with the data-mask bits, bank sets (S) 126-1 and (U) 126-3, respectively, store unmasked portions of the first write-data sequence and the second write-data sequence. Bank sets 126 in memory IC 124-1 each include one or more memory banks (such as DRAM), which are micro-threaded, meaning that they are independently addressable from each other and can concurrently perform operations associated with independent commands, including simultaneous column read/write. In the discussion that follows, such independent commands and the associated data are sometimes referred to as micro-threads. Examples of microthreaded memory banks can be found in commonly assigned U.S. Pat. No. 7,187,572 entitled “Early Read After Write Operation Memory Device, System and Method,” U.S. Pat. No. 7,380,092 entitled “Memory Device and System Having a Variable Depth Write Buffer and Preload Method,” U.S. patent application Ser. No. 11/853,708 entitled “Multi-Column Addressing Mode Memory System Including an Integrated Circuit Memory Device” filed on Sep. 30, 2004, and U.S. patent application Ser. No. 10/998,402 entitled “Multi-Mode Memory” filed on Nov. 29, 2004, each of which is incorporated herein by reference in its entirety.

To facilitate micro-threading, in some embodiments, particular queues 112, interface circuits in interface circuit 116-1, and corresponding interface circuits in interface circuit 116-2 are associated with a particular one of bank sets 126. For example, queue 112-1, interface circuits DQ_{A} and DQ_{C} in interface circuit 116-1, and interface circuits DQ_{A} and DQ_{C} in interface circuit 116-2 are associated with bank set (S) 126-1, and queue 112-2, interface circuits DQ_{B} and DQ_{D} in interface circuit 116-1, and interface circuits DQ_{B} and DQ_{D} in interface circuit 116-2 are associated with bank set (T) 126-2. Similarly, queue 112-3, interface circuits DQ_{E} and DQ_{G} in interface circuit 116-1, and interface circuits DQ_{E} and DQ_{G} in interface circuit 116-2 are associated with bank set (U) 126-3, and queue 112-4, interface circuits DQ_{F} and DQ_{H} in interface circuit 116-1, and interface circuits DQ_{F} and DQ_{H} in interface circuit 116-2 are associated with bank set (V) 126-4.

By interleaving the data-mask information for two different micro-threads, i.e., the first write-data-sequence and the second write-data sequence, and using alternate first and second data-mask information to control the masking of these micro-threads, as opposed to conveying block(s) of data-mask bits corresponding to the first write-data-sequence followed by conveying block(s) of data-mask bits corresponding to the second write-data-sequence, or vice versa, this communication technique reduces or eliminates the need to temporarily store the data-mask information in memory IC 124-1, which reduces the cost, complexity and power consumption of memory system 100. Thus, by changing the time and spatial allocation of the data-mask mapping information, this communication technique facilitates the use of micro-threads.

Commands and associated address(es) for operations to be performed in bank sets 126 may be communicated from memory controller 110 to memory IC 124-1 using unidirectional command links in links 122, which are connected to external nodes 118 in these components. In particular, control logic 114 may provide the commands and addresses corresponding to the write-data sequences on the command links. Commands and addresses associated with bank sets (S) 126-1 and (T) 126-2 may be transmitted by interface circuit CA_{K} in interface circuit 116-1 as amplitude-modulated electrical signals on the associated link, and commands and addresses associated with bank sets 126-3 and 126-4 may be transmitted by interface circuit CA_{L} in interface circuit 116-1 as amplitude-modulated electrical signals on the associated link. The corresponding interface circuit in interface circuit 116-2 sample and quantize these electrical signals to recover the digital information, which is then decoded by a decoder in control logic 128-1 and conveyed to the appropriate bank set(s) 126. The command(s) currently being processed and the associated address(es) in bank sets 126 may be communicated on the command links to memory IC 124-1 prior to the write-data sequences being communicated on the data link(s) 120. Instead of using the command links, in some embodiments the command and address information is conveyed on bidirectional data links 120 using in-band or side-band communication.

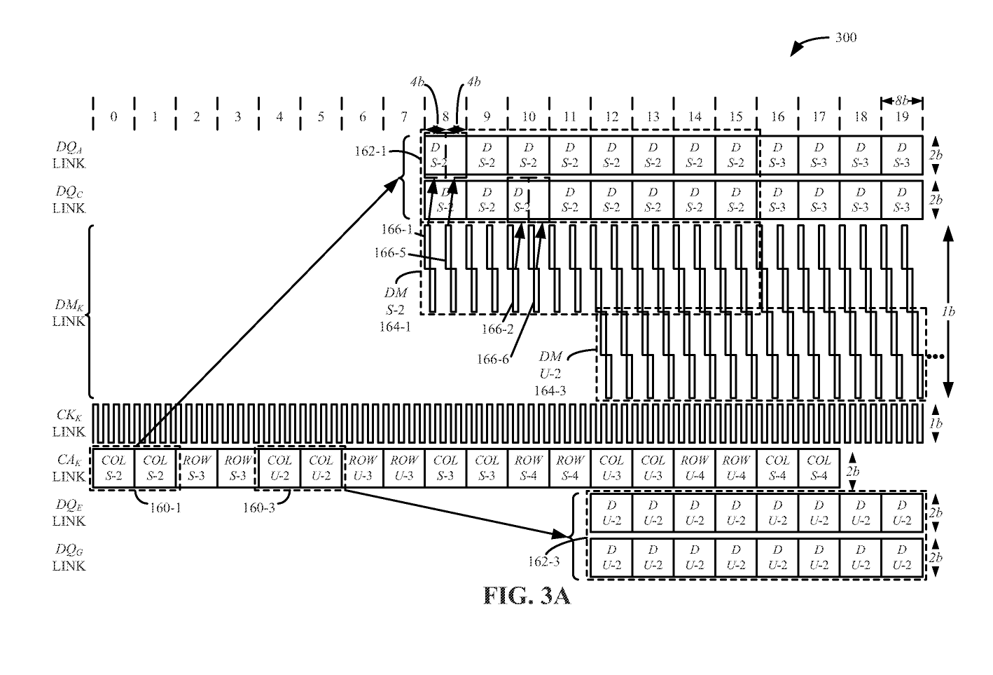

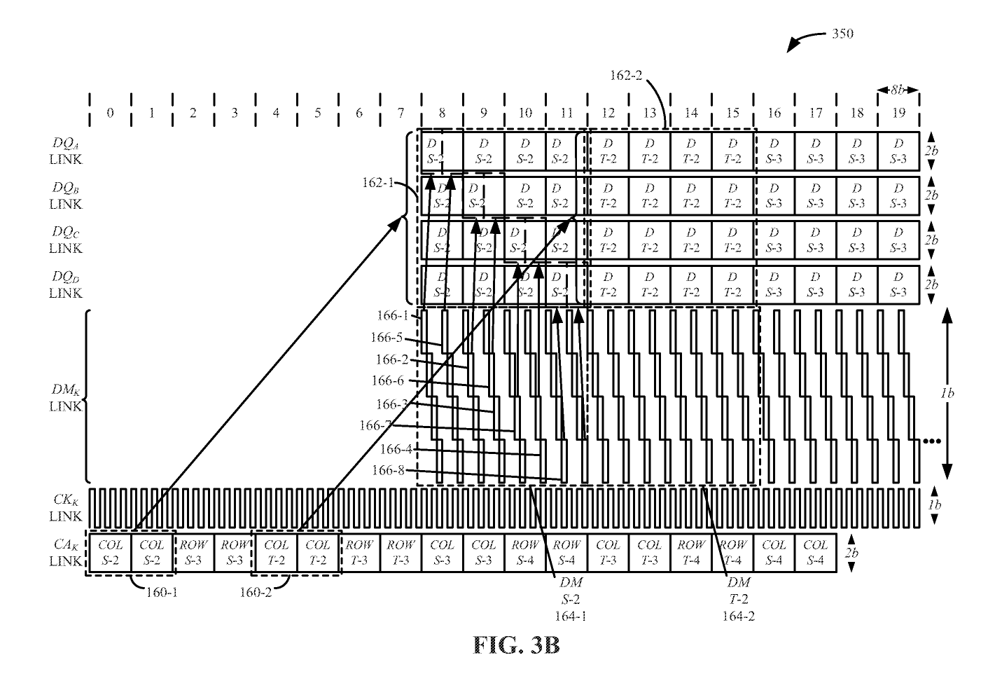

As described further below with reference to FIG. 3A, the command and address information corresponding to different microthreads may also be interleaved when being conveyed over a command link, but an interleaving format for the commands and addresses on the command link(s) is different from an interleaving format for the corresponding data-mask information on the data-mask link(s). For example, the command and addresses on a command link may be interleaved such that the row addresses corresponding to the first data sequence are followed by the row addresses corresponding to the second data sequence, while the column addresses corresponding to the first data sequence are followed by the column addresses corresponding to the second data sequence. The data-mask information corresponding to the two data sequences may be interleaved in a finer scale, such that multiple transitions between the first data-mask information and the second data-mask information may occur while one or more blocks of data-mask bits corresponding to the first data sequence and the second data sequence are conveyed. In particular, data-mask information (e.g., one or more data mask bits) corresponding to a first portion of the first data sequence may be followed by data-mask information corresponding to a first portion of the second data sequence, which is followed by data-mask information corresponding to a second portion of the first data sequence, which in turn is followed by data-mask information corresponding to a second portion of the second data sequence, and so forth if more data-mask information corresponding to the rest of the first and second data sequences are to be conveyed. For example, a data-mask block may include a first data-mask bit corresponds to a first portion of a first data block, an immediately adjacent second data-mask bit corresponds to a second portion of a second data block, an immediately adjacent third data-mask bit corresponds to a third portion of a third data block, etc.

While memory IC 124-1 is illustrated as having a single control logic 128-1, in some embodiments there are more than one control logic circuits. For example, there may be a first control logic associated with bank sets (S) 126-1 and (T) 126-2, and a second control logic associated with bank sets (U) 126-3 and (V) 126-4. In addition, other aspects of the hardware configuration in memory system 100 are also illustrations. Thus, there may be additional or fewer signal lines in data links 120, links 122 or both.

In some embodiments, memory controller 110 conveys data (such as the first write-data sequence and the second write-data sequence) and the interleaved data-mask information at a common bit rate. Communication of data on data links 120 may utilize half-duplex communication. In these embodiments, a respective data link may convey write data or read data, but not both at the same time.

Furthermore, in some embodiments, data to be communicated on bidirectional data links 120 is converted from parallel to serial prior to transmission by either memory controller 110 or memory IC 124-1, and from serial to parallel after being received by the corresponding component. For example, bidirectional data links 120 may each operate at 3200 MHz. Data on N parallel signal lines (such as 8 or 32 signal lines) in memory controller 110 and memory IC 124-1 may be communicated at 1/Nth of 3200 MHz.

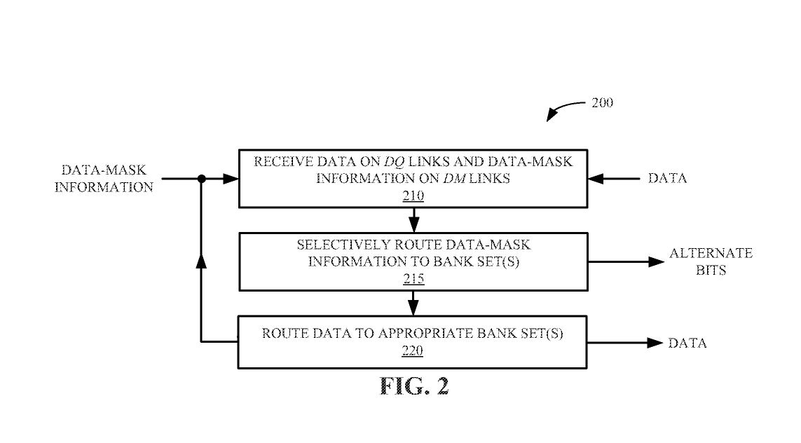

FIG. 2 presents a method 200 for communicating interleaved data-mask information between memory controller 110 and memory IC 124-1 in memory system 100 of FIG. 1, which may be performed, at least in part, by control logic 128-1. Beginning the process at operation 210, memory IC 124-1 receives at least two partially temporally overlapping write-data sequences (such as the first write-data sequence and the second write-data sequence) and the interleaved data-mask information from memory controller 110. Then, at operation 215, steering logic 130-1 in control logic 128-1 selectively steers alternate bits in the interleaved data-mask information, respectively, to the appropriate bank sets 126 in memory IC 124-1. For example, alternate data-mask bits may be, respectively, routed to bank sets (S) 126-1 and (U) 126-3.

At operation 220, control logic 128-1 routes the write-data sequences to the corresponding bank sets. For example, the first write-data sequence may be routed to bank set (S) 126-1, and the second write-data sequence may be routed to bank set (U) 126-3. At a respective bank set, unmasked portions of the respective write-data sequence are stored at an appropriate address(es) in accordance with the respective alternate bits in the data-mask information.

Process 200 may include fewer or additional operations. Moreover, two or more operations may be combined into a single operation and/or a position of one or more operations may be changed.

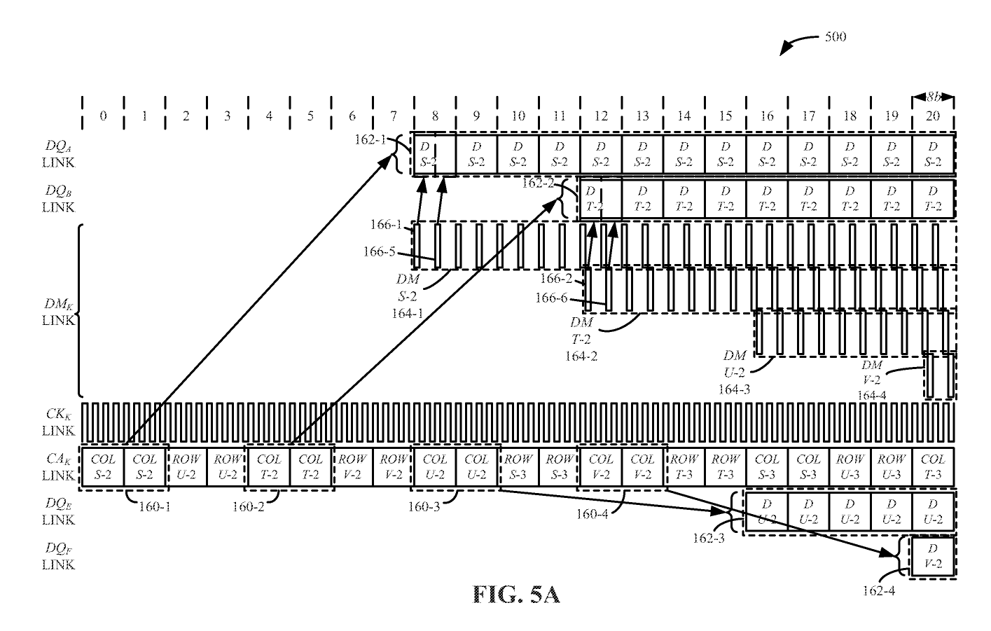

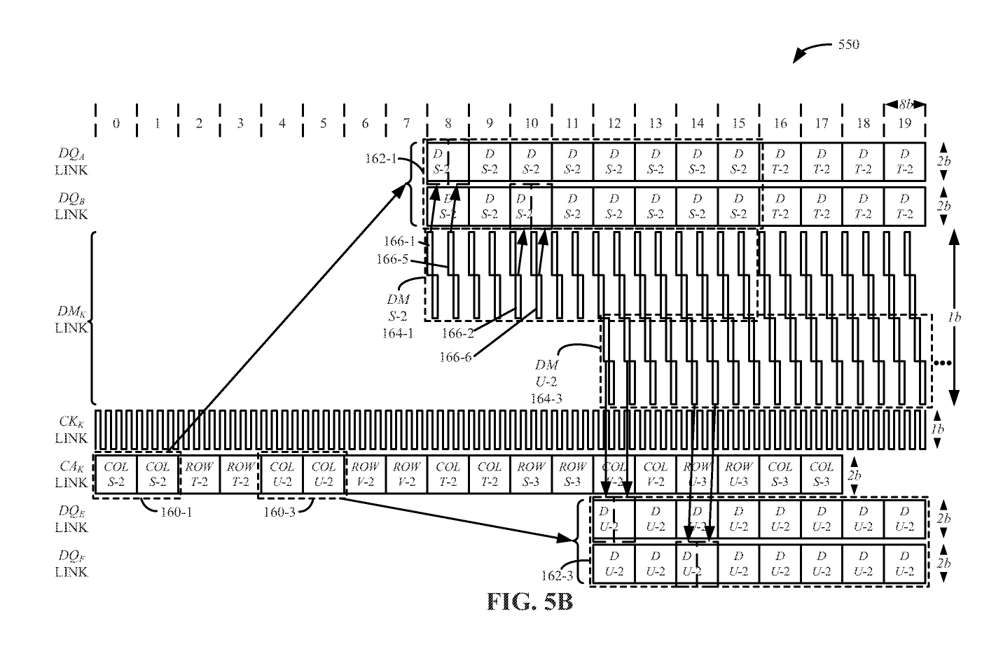

As an example, FIG. 3A presents a timing diagram 300 for communication between memory controller 110 and memory IC 124-1 in memory system 100 of FIG. 1. During time intervals 0-19 in this example, the unidirectional command link associated with interface circuit CA_{K} (which is henceforth referred to as the CA_{K} link) conveys column and row write commands, and unidirectional clock link associated with interface circuit CK_{K} (which is henceforth referred to as the CK_{K} link) conveys a clock signal. Furthermore, bidirectional data links associated with interface circuits DQ_{A}, DQ_{C}, DQ_{E} and DQ_{G} (which are henceforth referred to as DQ_{A}, DQ_{C}, DQ_{E} and DQ_{G} links) convey write data (in particular, a first write-data sequence is conveyed on the DQ_{A} and DQ_{C} links, and a second write-data sequence for an independent column write access or micro-thread is conveyed on the DQ_{E} and DQ_{G} links), and unidirectional data-mask link (which is henceforth referred to as the DM_{K} link) conveys interleaved data-mask information. In FIG. 3A (and FIGS. 3B, 5A and 5B below), each block of write data in each time interval represents sixteen bits communicated on two parallel data signal lines (8 bits long×2 signal lines). Similarly, each command block in each time interval represents sixteen bits communicated on two parallel command signal lines (8 bits long×2 signal lines). Furthermore, each data-mask block includes eight bits communicated on one data-mask signal line (8 bits long×1 signal line), and during each time interval, the CK_{K} link conveys eight bit times or four clock periods on one signal line. In some embodiments, each time interval has a duration of 2.5 ns.

The timing of the DQ_{A}, DQ_{C}, DQ_{E}, DQ_{G}, DM_{K}, CK_{K}, and CA_{K} links can be similar to the DQ_{B}, DQ_{D}, DQ_{F}, DQ_{H}, DM_{L}, CK_{L}, and CA_{L} links, so only the DQ_{A}, DQ_{C}, DQ_{E}, DQ_{G}, DM_{K}, CK_{K}, and CA_{K} links are shown in FIG. 3A. In this example, sixteen data blocks on the DQ_{A} and DQ_{C} links (with eight data blocks on each data link) are used to communicate write data sequence 162-1 (corresponding to write command to column S-2 160-1 on the CA_{K} link) to bank set (S) 126-1, and sixteen data blocks on the DQ_{E} and DQ_{G} links (with eight data blocks on each data link) are used to communicate write data 162-3 (corresponding to the write command to column U-2 160-3 on the CA_{K} link) to bank set (U) 126-3.

The DM_{K} link contains interleaved data-mask information DM S-2 164-1 and DM U-2 164-3 for the two different micro-threads. The interleaving format on the DM_{K} link is different than the interleaving format for the two micro-threads on the CA_{K} link. In particular, the column or row commands are conveyed such that the row commands corresponding to a whole data sequence or to a group of data blocks in a data sequence are consecutively conveyed without being interrupted by the conveying of the row commands corresponding to data blocks in another data sequence. In contrast, data-mask information corresponding to portions of a data block in the first data sequence is interleaved with data-mask information corresponding to portions of a data block in the second data sequence. There is no temporal overlap of the data-mask information on a DM_{K} link. At a respective time, a data-mask bit in a data-mask block corresponds to a particular portion of a respective data block. In FIG. 3A (and in FIGS. 3B, 5A and 5B below), the data-mask bits in each data-mask block that control the masking of write data on different data links are offset for clarity.

The identification (e.g., start time) of the data-mask information for respective write data is determined by the corresponding write command on the CA_{K} link. For example, data-mask bits for corresponding portions of data blocks S-2 may be communicated on the DM_{K} link eight time intervals after the write command for column S-2 is communicated on the CA_{K} link.

In one embodiment, each bit in a respective data-mask block controls the masking of eight write-data bits on a respective data link (or four bits on each of two signal lines). For example, when a data-mask bit is a logical ‘1’ may dictate that the data stored at a corresponding memory address in the associated bank set is not to be overwritten. Furthermore, the alignment between the write data and the data-mask information is maintained to minimize the storage requirements for the data-mask information on memory IC 124-1. For example, only one data-mask bit may need to be temporarily stored to control the masking of eight write-data bits.

In FIG. 3A, the first and fifth data-mask bits in each data-mask block (such as bits 166-1 and 166-5) control the masking of the first and second halves, respectively, of the write data in a data block on the DQ_{A} link, and the second and sixth data-mask bits in each data-mask block (such as bits 166-2 and 166-6) control the masking of the first and second halves, respectively, of the write data in a data block on the DQ_{C} link. Similarly, the third and seventh data-mask bits in each data-mask block control the masking of the first and second halves, respectively, of the write data in a data block on the DQ_{E} link, and the fourth and eight data-mask bits in each data-mask block control the masking of the first and second halves, respectively, of the write data in a data block on the DQ_{G} link. Thus, alternate bits on the DM_{K} link control the write masking on different data links. Also, the first, second, fifth and sixth data-mask bits in a data-mask block correspond to respective portions of the first data sequence, and are thus first data-mask information. Likewise, the third, fourth, seventh, and eighth data-mask bits in a data-mask block correspond to respective portions of the second data sequence, and are thus second data-mask information. Therefore, to convey one block of data-mask bits, the DM_{K} link starts with conveying first data-mask information, then transitions to convey second data-mask information. Afterwards, it makes another transition to convey more first data-mask information, and then another transition again to convey more second data-mask information. In other words, multiple transitions (e.g., 3) between first data-mask information and second data-mask information can occur on a data-mask link (e.g., the DM_{K} link) while one block of data-mask bits are conveyed. Such a pattern of interleaving first data-mask information and second data-mask information may be repeated for subsequent data-mask blocks on the DM_{K} link until write data 162 for either or both micro-threads are completed.

In another embodiment of memory system 100, at a respective time, the DQ_{A}, DQ_{B}, DQ_{C}, and DQ_{A} links convey write data to (or read data from) either bank set 126-1 (S) or (T) 126-2, and the DQ_{E}, DQ_{F}, DQ_{G} and DQ_{H} links convey write data to (or read data from) either bank set (U) 126-3 or (V) 126-4. Communication for this configuration is illustrated in FIG. 3B, which presents a timing diagram 350 for communication between memory controller 110 and memory IC 124-1 in memory system 100 of FIG. 1. During time intervals 0-19 in this example, unidirectional CA_{K} link conveys column and row write commands, unidirectional CK_{K} link conveys a clock signal, bidirectional data links associated with DQ_{A}, DQ_{B}, DQ_{C} and DQ_{D} (which are henceforth referred to as DQ_{A}, DQ_{B}, DQ_{C} and DQ_{D} links) convey write data, and unidirectional DM_{K} link conveys interleaved data-mask information.

Because the timing of the DQ_{A}, DQ_{B}, DQ_{C}, DQ_{D}, DM_{K}, CK_{K}, and CA_{K} links can be similar to the DQ_{E}, DQ_{F}, DQ_{G}, DQ_{H}, DM_{L}, CK_{L}, and CA_{L} links, only the DQ_{A}, DQ_{B}, DQ_{C}, DQ_{D}, DM_{K}, CK_{K}, and CA_{K} links are shown in FIG. 3B. In this example, sixteen data blocks on the DQ_{A}, DQ_{B}, DQ_{C}, and DQ_{D} links (with four data blocks on each data link) are used to communicate write data 162-1 to bank set (S) 126-1, and then these data links are used to communicate sixteen data blocks (with four data blocks on each data link) in write data 162-2 to bank set (T) 126-2.

The DM_{K} link contains interleaved data-mask information DM S-2 164-1 and DM T-2 164-2 for the two different micro-threads. The interleaving format on the DM_{K} link is different than the interleaving format for the two micro-threads on the CA_{K} links (i.e., write command to column S-2 160-1 and write command to column T-2 160-2). Each bit in a data-mask block controls the masking of eight write-data bits on a respective data link (four bits on two signal lines). In FIG. 3B, the first and fifth data-mask bits in each data-mask block (such as bits 166-1 and 166-5) control the masking of the first and second halves, respectively, of the write data in a data block on the DQ_{A} link, the second and sixth data-mask bits in each data-mask block (such as bits 166-2 and 166-6) control the masking of the first and second halves, respectively, of the write data in a data block on the DQ_{B} link, the third and seventh data-mask bits in each data-mask block (such as bits 166-3 and 166-7) control the masking of the first and second halves, respectively, of the write data in a data block on the DQ_{C} link, and the fourth and eighth data-mask bits in each data-mask block (such as bits 166-4 and 166-8) control the masking of the first and second halves, respectively, of the write data in a data block on the DQ_{D} link. Thus, alternate bits on the DM_{K} link control the write masking on different data links (and, over four time intervals, for different micro-threads). This pattern may be repeated for subsequent data-mask blocks on the DM_{K} link until write data 162 for the micro-threads is completed.

In some embodiments, steering logic 130-1 can be configured or is configurable depending upon the number of bank sets, memory ICs, or both in the memory system. In particular, steering logic 130-1 may be adapted such that a number of alternate data-mask bits in the data-mask information corresponding to a respective write-data sequence is a function of a number of bank sets, memory ICs, or both. For example, a product of the number of alternate data-mask bits corresponding to the respective write-data sequence and a number of write-data bits in the respective write-data sequence controlled by the respective data-mask bit (i.e., whose masking is controlled by the respective data-mask bit) may be a constant as a function of the number of bank sets in a respective memory IC. Thus, the number of write-data bits controlled by the data-mask bits may be constant.

Although FIG. 1 shows the memory device 124-1 as including one memory IC, in practice, memory device 124-1 can include multiple memory ICs, which can be in separate packages, in a same package, on a same printed circuit board, or on different printed circuit boards. In such cases, the width of the data links can vary with the number of memory ICs, the way the data-mask bits are applied, or both. For example, a number of write-data bits received via the data links 120 during a time interval for a respective write-data sequence may be a function of a number of bank sets in a respective memory IC.

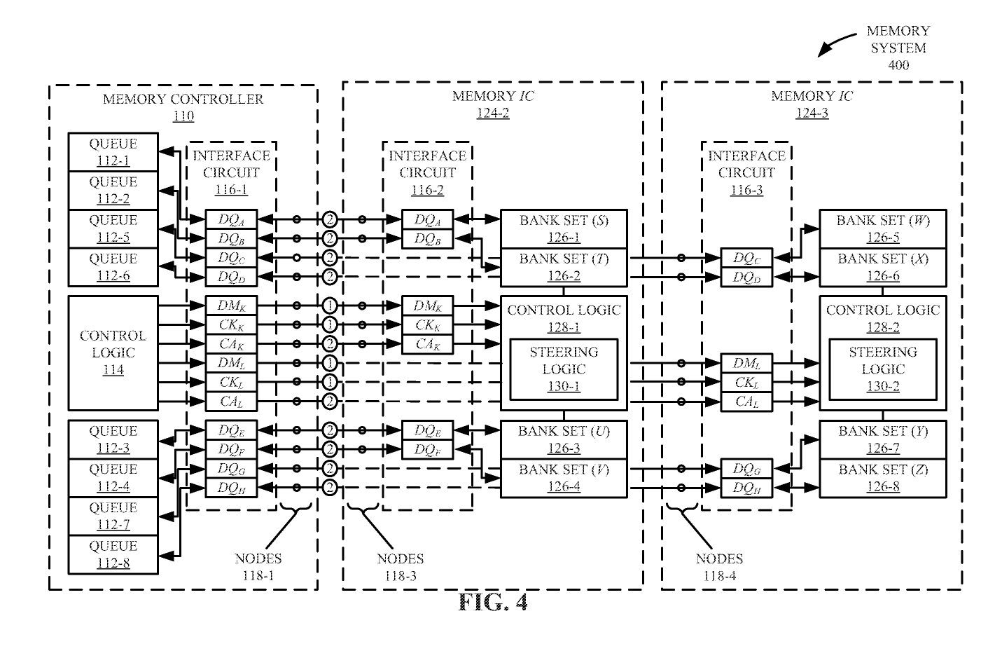

One such alternative configuration is illustrated in FIG. 4, which presents a memory system 400 with interleaved data-mask information during communication between memory controller 110 and a memory device 124 including two memory ICs 124-2 and 124-3. For convenience, data links 120 and links 122 are not labeled in FIG. 4. In this example, data links associated with interface circuits DQ_{A}, DQ_{B}, DQ_{E} and DQ_{F}, convey write data to (and read data from) bank sets (S) 126-1, (T) 126-2, (U) 126-3 and (V) 126-4, respectively, in memory IC 124-2. Similarly, data links associated with interface circuits DQ_{C}, DQ_{D}, DQ_{G} and DQ_{H}, respectively, convey write data to (and read data from) bank sets (W) 126-5, (X) 126-6, (Y) 126-7 and (Z) 126-8 in memory IC 124-3.

Communication for this configuration is illustrated in FIG. 5A, which presents a timing diagram 500 for communication between memory controller 110 and memory ICs 124 in memory system 400 of FIG. 4. During time intervals 0-20 in this example (and in FIG. 5B below), unidirectional CA_{K} link conveys column and row write commands, unidirectional CK_{K} link conveys a clock signal, bidirectional data links associated with interface circuits DQ_{A}, DQ_{B}, DQ_{E} and DQ_{F} (which are henceforth referred to as DQ_{A}, DQ_{B}, DQ_{E} and DQ_{F} links) convey write data, and unidirectional DM_{K} link conveys interleaved data-mask information.

Because the timing of the DQ_{A}, DQ_{B}, DQ_{E}, DQ_{F}, DM_{K}, CK_{K}, and CA_{K} links can be similar to the DQ_{C}, DQ_{D}, DQ_{G}, DQ_{H}, DM_{L}, CK_{L}, and CA_{L} links, only the DQ_{A}, DQ_{B}, DQ_{E}, DQ_{F}, DM_{K}, CK_{K}, and CA_{K} links are shown in FIG. 5A (and in FIG. 5B below). In this example, a data sequence 162-1 of sixteen data blocks of write data are communicated on the DQ_{A} link to bank set (S) 126-1, a data sequence 162-2 of sixteen data blocks of write data are communicated on the DQ_{B} link to bank set (T) 126-2, a data sequence 162-3 of sixteen data blocks of write data are communicated on the DQ_{E} link to bank set (U) 126-3, and a data sequence 162-4 of sixteen data blocks of write data are communicated on the DQ_{F} link to bank set (V) 126-4.

The DM_{K} link conveys interleaved data-mask information including data-mask information DM S-2 164-1, DM T-2 164-2, DM U-2 164-3 and DM V-2 164-4 for the four different data sequences 162-1, 162-2, 162-3, and 162-4.

Each bit in a data-mask block controls the masking of eight write-data bits conveyed on a respective data link (four bits on each of two signal lines). In FIG. 5A, the first and fifth data-mask bits in each data-mask block (such as bits 166-1 and 166-5) control the masking of the first and second halves, respectively, of the write data in a data block in data sequence 162-1, the second and sixth data-mask bits in each data-mask block (such as bits 166-2 and 166-6) control the masking of the first and second halves, respectively, of the write data in a data block in data sequence 162-2, the third and seventh data-mask bits in each data-mask block control the masking of the first and second halves, respectively, of the write data in a data block in data sequence 162-3, and the fourth and eighth data-mask bits in each data-mask block control the masking of the first and second halves, respectively, of the write data in a data block in data sequence 162-4. Thus, alternate bits on the DM_{K} link control the write masking on different data links and for different micro-threads, and as many as 7 (or 8) transitions between data-mask information corresponding to different data sequences can occur on the data-mask link while a block of data-mask bits is conveyed. This pattern may be repeated for subsequent data-mask blocks on the DM_{K} link until write data 162 for one or more of the micro-threads is completed.

In another embodiment of memory system 400, at a respective time, the DQ_{A} and DQ_{B} links convey write data to (or read data from) either bank set 126-1 or 126-2, the DQ_{E} and DQ_{F} links convey write data to (or read data from) either bank set 126-3 or 126-4, the DQ_{C} and DQ_{D} links convey write data to (or read data from) either bank set 126-5 or 126-6, and the DQ_{G} and DQ_{H} links convey write data to (or read data from) either bank set 126-7 or 126-8.

Communication for this configuration is illustrated in FIG. 5B, which presents a timing diagram 550 for communication between memory controller 110 and memory ICs 124 in memory system 400 of FIG. 4. In this example, sixteen data blocks in write data 162-1 are conveyed on the DQ_{A} and DQ_{B} links to bank set 126-1 (with eight data blocks on each data link), and sixteen data blocks in write data 162-3 are conveyed on the DQ_{E} and DQ_{F} links to banks set 126-3 (with eight data blocks on each data link).

The DM_{K} link contains interleaved data-mask information DMS-2 164-1 and DM U-2 164-3 for the two different micro-threads. In particular, portions of the data-mask information (such as data-mask bits) corresponding to portions of data blocks are interleaved, as opposed to interleaving the data-mask information for a group of blocks (which is associated with a column or row command). Similarly, and in contrast with the write data for the micro-threads on the data links, there is no temporal overlap of the data-mask information on the DM_{K} link. At a respective time, the data-mask bit in a data-mask block corresponds to a particular portion of a respective data block.

Each bit in a data-mask block controls the masking of eight write-data bits on a respective data link (four bits on two signal lines). In FIG. 5B, the first and fifth data-mask bits in each data-mask block (such as bits 166-1 and 166-5) control the masking of the first and second halves, respectively, of the write data in a data block on the DQ_{A} link, the second and sixth data-mask bits in each data-mask block (such as bits 166-2 and 166-6) control the masking of the first and second halves, respectively, of the write data in a data block on the DQ_{B} link, the third and seventh data-mask bits in each data-mask block control the masking of the first and second halves, respectively, of the write data in a data block on the DQ_{E} link, and the fourth and eighth data-mask bits in each data-mask block control the masking of the first and second halves, respectively, of the write data in a data block on the DQ_{F} link. Thus, alternate bits on the DM_{K} link control the write masking on different data links and multiple transitions (e.g., 3) between data-mask information corresponding to different microthreads can occur on a data-mask link (e.g., DM_{K} link) while one block of data-mask bits is conveyed. This pattern may be repeated for subsequent data-mask blocks on the DM_{K} link until write data 162 for either or both of the micro-threads is completed.

Although FIG. 4 shows that bank sets (S) 126-1, (T) 126-2, (U) 126-3, (V) 126-4, (W) 126-5, (X) 126-6, (Y) 126-7 and (Z) 126-8 are distributed over two memory ICs, in practice, bank sets (S) 126-1, (T) 126-2, (U) 126-3, (V) 126-4, (W) 126-5, (X) 126-6, (Y) 126-7 and (Z) 126-8 may also be on the same memory IC, and the above discussion with reference with FIG. 5A and FIG. 5B should apply to this situation with slight modification.

In the foregoing description and in the accompanying drawings, specific terminology and drawing symbols are set forth to provide a thorough understanding of the present invention. In some instances, the terminology and symbols may imply specific details that are not required to practice the invention. Consequently, these embodiments may include fewer components or additional components. Moreover, components may be combined into a single component and/or the position of one or more components may be changed.

While the preceding embodiments used a memory system implemented on separate integrated circuits as an illustration, memory controller 110 and memory IC 124-1 in FIG. 1 may be implemented on a single integrated circuit or different integrated circuits. For example, memory controller 110 may be included on a processor in a computer system. Furthermore, in some embodiments, an equivalent means for storing the unmask portions of the write-data sequences is used instead of bank sets 126.

An output of a process for designing an integrated circuit, or a portion of an integrated circuit, comprising one or more of the circuits described herein may be a computer-readable medium such as, for example, a magnetic tape or an optical or magnetic disk. The computer-readable medium may be encoded with data structures or other information describing circuitry that may be physically instantiated as an integrated circuit or portion of an integrated circuit. Although various formats may be used for such encoding, these data structures are commonly written in Caltech Intermediate Format (CIF), Calma GDS II Stream Format (GDSII) or Electronic Design Interchange Format (EDIF). Those of skill in the art of integrated circuit design can develop such data structures from schematic diagrams of the type detailed above and the corresponding descriptions and encode the data structures on a computer-readable medium. Those of skill in the art of integrated circuit fabrication can use such encoded data to fabricate integrated circuits comprising one or more of the circuits described herein.

While the present invention has been described in connection with specific embodiments, the claims are not limited to what is shown. For example, in some embodiments the links between memory controller 110 and memory IC 124-1 in FIG. 1 may utilize full-duplex communication. Similarly, data or commands may be communicated using other encoding or modulation techniques. For example, embodiments of the invention may be adapted for use with multi-pulse-amplitude-encoded (multi-PAM) signals.

Moreover, some components are shown directly connected to one another, while others are shown connected via intermediate components. In each instance the method of communication establishes some desired electrical communication between two or more circuit nodes, or terminals. Such coupling may often be accomplished using a number of circuit configurations, as will be understood by those of skill in the art. For example, the foregoing embodiments support AC-coupled links, DC-coupled links, or both. Therefore, the spirit and scope of the appended claims should not be limited to the foregoing description. Only those claims specifically reciting “means for” or “step for” should be construed in the manner required under the sixth paragraph of 35 U.S.C. §112.

What is claimed is:

1. A memory device, comprising:
data interface circuits to electrically couple to a memory controller via data links, the data interface circuits to receive a first data sequence and a second data sequence from the memory controller, the first data sequence, at least in part, temporally overlapping the second data sequence, the first data sequence and the second data sequence corresponding to different column write accesses, respectively;
a first bank set, which includes one or more banks, electrically coupled to at least a first subset of the data interface circuits, the first bank set to store an unmasked portion of the first data sequence;
a second bank set, which includes one or more banks, electrically coupled to at least a second subset of the data interface circuits, the second bank set to store an unmasked portion of the second data sequence; and
a data-mask interface circuit to electrically couple to the memory controller via a data-mask link, the data-mask interface circuit to receive temporally interleaved data-mask information, the temporally interleaved data-mask information including at least a first transition from first data-mask information to second data-mask information and a second transition from third data-mask information to fourth data-mask information, the first data-mask information corresponding to a first portion of the first data sequence, the second data-mask information corresponding to a first portion of the second data sequence, the third data-mask information corresponding to a second portion of the first data sequence, and the fourth data-mask information corresponding to a second portion of the second data sequence.

2. The memory device of claim 1, further comprising data-mask steering logic to selectively steer the first data-mask information and the second data-mask information, respectively, to the first bank set and the second bank set.

3. The memory device of claim 2, wherein the data-mask steering logic is adapted such that a number of data-mask bits in the data-mask information corresponding to a respective data sequence is a function of a number of bank sets in the memory device.

4. The memory device of claim 3, wherein a product of the number of data-mask bits corresponding to a respective data sequence and a number of bits in the respective data sequence corresponding to a respective data-mask bit is independent of the number of bank sets in the memory device.

5. The memory device of claim 1, further comprising a command interface circuit to electrically couple to the memory controller via a command link, the command interface circuit to receive commands for the column write access for the first data sequence and the column write access for the second data sequence.

6. The memory device of claim 5, wherein the commands include a row command associated with the first data sequence, followed by a row command associated with the second data sequence, followed by a column command associated with the first data sequence, and followed by a column command associated with the second data sequence.

7. The memory device of claim 5, wherein the commands include a row command associated with the first data sequence, followed by a column command associated with the first data sequence, followed by a row command associated with the second data sequence, and followed by a column command associated with the second data sequence.

8. The memory device of claim 1, wherein the data interface circuits include:
a first data interface circuit to electrically couple to the memory controller via a first data link in the data links, the first data interface circuit to receive the first data sequence from the memory controller; and
a second data interface circuit to electrically couple to the memory controller via a second data link in the data links, the second data interface circuit to receive the second data sequence from the memory controller; and
wherein the first subset of the interface circuits includes the first data interface circuit and the second subset of the interface circuits includes the second data interface circuit.

9. The memory device of claim 1, wherein the first data-mask information includes at least one first data-mask bit in a data-mask block and the second data-mask information includes at least one second data-mask bit adjacent the at least one first data-mask bit in the data-mask block.

10. The memory device of claim 1, wherein the first bank set and the second bank set are independently addressable and can concurrently perform operations associated with independent commands.

11. The memory device of claim 1, wherein the data interface circuits to further receive a third data sequence and a fourth data sequence from the memory controller, the fourth data sequence, at least in part, temporally overlapping at least one of the first, second and the third data sequences, the first, second, third and fourth data sequences corresponding to different column write accesses, respectively;
wherein the memory device further includes a third bank set to store an unmasked portion of the third data sequence and a fourth bank set to store an unmasked portion of the fourth data sequence; and
wherein the temporally interleaved data-mask information further includes fifth data-mask information corresponding to a portion of the third data sequence and sixth data-mask information corresponding to a portion of the fourth data sequence, the temporally interleaved data-mask information further includes a third transition from the sixth data-mask information to one of the first, second, third, fourth and fifth data-mask information, the third transition being temporally between the first transition and the second transition.

12. The memory device of claim 11, wherein the memory device includes a first memory integrated circuit and a second memory integrated circuit, wherein the first and second bank sets are on the first memory integrated circuit while the third and fourth bank sets are on the second memory integrated circuit.

13. The memory device of claim 1, wherein the memory device receives the first data sequence, the second data sequence and the data-mask information at a common bit rate.

14. The memory device of claim 1, wherein a number of bits received via the data links during a clock period for a respective data sequence is a function of a number of bank sets in the memory device.

15. A memory device, comprising:
data interface circuits to electrically couple to a memory controller via data links, the data interface circuits to receive a first data sequence and a second data sequence from the memory controller, the first data sequence, at least in part, temporally overlapping the second data sequence, and the first data sequence corresponding to a different column write access than the second data sequence;
first means for storing an unmasked portion of the first data sequence, which is electrically coupled to at least a subset of the data interface circuits;
second means for storing an unmasked portion of the second data sequence, which is electrically coupled to at least another subset of the data interface circuits; and
a data-mask interface circuit to electrically couple to the memory controller via a data-mask link, the data-mask interface circuit to receive temporally interleaved data-mask information, the temporally interleaved data-mask information including at least a first transition from first data-mask information to second data-mask information and a second transition from third data-mask information to fourth data-mask information, the first data-mask information corresponding to a first portion of the first data sequence, the second data-mask information corresponding to a first portion of the second data sequence, the third data-mask information corresponding to a second portion of the first data sequence, and the fourth data-mask information corresponding to a second portion of the second data sequence.

16. A memory controller, comprising:
data interface circuits to electrically couple to a memory device via data links, the data interface circuits to output a first data sequence and a second data sequence to the memory device, the first data sequence, at least in part, temporally overlapping the second data sequence, and the first data sequence and the second data sequence corresponding to different column write accesses, respectively; and
a data-mask interface circuit to electrically couple to the memory device via a data-mask link, the data-mask interface circuit to output temporally interleaved data-mask information, the temporally interleaved data-mask information including at least a first transition from first data-mask information to second data-mask information and a second transition from third data-mask information to fourth data-mask information, the first data-mask information corresponding to a first portion of the first data sequence, the second data-mask information corresponding to a first portion of the second data sequence, the third data-mask information corresponding to a second portion of the first data sequence, and the fourth data-mask information corresponding to a second portion of the second data sequence.

17. The memory controller of claim 16, wherein a number of data-mask bits in the data-mask information corresponding to a respective data sequence is a function of a number of bank sets in the memory device.

18. The memory controller of claim 17, wherein a product of the number of data-mask bits corresponding to the respective data sequence and a number of bits in the respective data sequence corresponding to a respective data-mask bit is independent of the number of bank sets in the memory device.

19. The memory controller of claim 16, further comprising a command interface circuit to electrically couple to the memory device via a command link, the command interface circuit to provide commands for the column write access for the first data sequence and the column write access for the second data sequence.

20. The memory controller of claim 16, wherein the data interface circuits include:
a first data interface circuit to electrically couple to the memory device via a first data link in the data links, the first data interface circuit to provide the first data sequence to the memory device; and
a second data interface circuit to electrically couple to the integrated circuit via a second data link in the data links, the second data interface circuit to provide the second data sequence to the memory device.

21. The memory controller of claim 16, wherein the first data-mask information includes at least one first data-mask bit in a data-mask block and the second data-mask information includes at least one second data-mask bit adjacent the at least one first data-mask bit in the data-mask block.

22. The memory controller of claim 16, wherein the memory controller provides the first data sequence, the second data sequence and the data-mask information at a common bit rate.

23. The memory controller of claim 16, wherein a number of bits provided via the data links during a clock period for a respective data sequence is a function of a number of bank sets in the memory device.

24. The memory controller of claim 16, wherein the data interface circuits to further output a third data sequence and a fourth data sequence, the fourth data sequence, at least in part, temporally overlapping at least one of the first, second and the third data sequences, the first, second, third and fourth data sequences corresponding to different column write accesses, respectively; and
wherein the temporally interleaved data-mask information further includes fifth data-mask information corresponding to a portion of the third data sequence and sixth data-mask information corresponding to a portion of the fourth data sequence, the temporally interleaved data-mask information further includes a third transition from the sixth data-mask information to one of the first, second, third, fourth and fifth data-mask information, the third transition being temporally between the first transition and the second transition.

25. A system comprising:
a memory controller;
a memory device having first and second banks sets; and
data links and data-mask links coupled between the memory controller and the memory device;
wherein the memory controller is to provide a first data sequence and a second data sequence to the memory device via the data links, the first data sequence, at least in part, temporally overlapping the second data sequence, the first data sequence and the second data sequence corresponding to different column write accesses, respectively;
wherein the memory controller is to further provide temporally interleaved data-mask information to the memory device over the data-mask links, the temporally interleaved data-mask information including at least a first transition from first data-mask information to second data-mask information and a second transition from third data-mask information to fourth data-mask information, the first data-mask information corresponding to a first portion of the first data sequence, the second data-mask information corresponding to a first portion of the second data sequence, the third data-mask information corresponding to a second portion of the first data sequence, and the fourth data-mask information corresponding to a second portion of the second data sequence; and
wherein the memory device is to receive the first data sequence and the second data sequence, and is to store the first data sequence in the first bank set and the second data sequence in the second bank set.

26. The system of claim 25, wherein the memory device further includes a steering logic to steer the first data-mask information to the first bank set and the second data-mask information to the second bank set.

27. The system of claim 25, wherein the memory controller is to output a third data sequence and a fourth data sequence, the fourth data sequence, at least in part, temporally overlapping at least one of the first, second and third data sequences, the first, second, third and fourth data sequences corresponding to different column write accesses, respectively;
wherein the temporally interleaved data-mask information further includes fifth data-mask information corresponding to a portion of the third data sequence and sixth data-mask information corresponding to a portion of the fourth data sequence;
wherein the temporally interleaved data-mask information further includes a third transition from the sixth data-mask information to one of the first, second, third, fourth and fifth data-mask information, the third transition being temporally between the first transition and the second transition; and
wherein the memory device further includes a third bank set and a fourth bank set and is to receive the third data sequence and the fourth data sequence, and is to store the third data sequence in the third bank set and the sixth data sequence in the fourth bank set.

28. The system of claim 27, wherein the memory device includes a first memory integrated circuit and a second memory integrated circuit;
wherein the first and second bank sets are on the first memory integrated circuit; and
wherein the third and fourth bank sets are on the second memory integrated circuit,

29. A method for masking data in a memory device, comprising:
receiving a first data sequence and a second data sequence from a memory controller, the first data sequence, at least in part, temporally overlapping the second data sequence, the first data sequence corresponding to a first column write access while the second data sequence corresponding to a second column write access different from the first column write access; and
receiving temporally interleaved data-mask information from the memory controller, the temporally interleaved data-mask information including at least a first transition from first data-mask information to second data-mask information and a second transition from third data-mask information to fourth data-mask information, the first data-mask information corresponding to a first portion of the first data sequence, the second data-mask information corresponding to a first portion of the second data sequence, the third data-mask information corresponding to a second portion of the first data sequence, and the fourth data-mask information corresponding to a second portion of the second data sequence.

30. The method of claim 29, further comprising selectively steering the first and second data-mask information, respectively, to a first bank set and a second bank set in the memory device.

31. The method of claim 30, further comprising:
storing the unmasked portion of the first data sequence in the first bank set in accordance with the first and third data-mask information corresponding to the first data sequence; and
storing the unmasked portion of the second data sequence in the second bank set in accordance with the second and fourth data-mask information corresponding to the second data sequence.

32. A method of masking data by a memory controller, comprising:
providing a first data sequence and a second data sequence to a memory device, the first data sequence, at least in part, temporally overlapping the second data sequence, the first data sequence and the second data sequence corresponding to a different column write accesses, respectively; and
providing temporally interleaved data-mask information, the temporally interleaved data-mask information including at least a first transition from first data-mask information to second data-mask information and a second transition from third data-mask information to fourth data-mask information, the first data-mask information corresponding to a first portion of the first data sequence, the second data-mask information corresponding to a first portion of the second data sequence, the third data-mask information corresponding to a second portion of the first data sequence, and the fourth data-mask information corresponding to a second portion of the second data sequence.
